(19) United States
(12) Patent Application Publication
(10) Pub. No.: US 2023/0214676 A1
(43) Pub. Date: Jul. 6, 2023

(54) PREDICTION MODEL TRAINING METHOD, INFORMATION PREDICTION METHOD AND CORRESPONDING DEVICE

(71) Applicant: SAMSUNG ELECTRONICS CO., LTD., Suwon-si (KR)

(72) Inventors: Jinfu WANG, Beijing (CN); Shuchen LI, Beijing (CN); Yongheng ZHAI, Beijing (CN)

(73) Assignee: SAMSUNG ELECTRONICS CO., LTD., Suwon-si (KR)

(21) Appl. No.: 18/120,816

(22) Filed: Mar. 13, 2023

Related U.S. Application Data
(63) Continuation of application No. PCT/KR2022/014511, filed on Sep. 28, 2022.

(30) Foreign Application Priority Data
Sep. 29, 2021 (CN) 202111154399.5

(51) Int. Cl. G06N 5/022; G06N 5/04

(52) U.S. Cl. CPC G06N 5/022; G06N 5/04

(57) ABSTRACT

A prediction model training method includes transmitting a model to be trained by a plurality of training devices, the model to be trained including feature extraction layers and prediction layers, classifying the plurality of training devices into at least one group based on extracted user features, receiving, from the plurality of training devices, model parameters including first parameters corresponding to the feature extraction layers and second parameters corresponding to the prediction layers, performing global federated aggregation based on the first parameters, performing intra-group federated aggregation for each of the at least one group, based on the second parameters of one or more of the plurality of training devices in a respective group, and transmitting, to the plurality of training devices, the global federated aggregation result and the intra-group federated aggregation result.

### CROSS-REFERENCE TO RELATED APPLICATION(S)

This application is a bypass continuation of International Application No. PCT/KR2022/014511, filed on Sep. 28, 2022, which is based on and claims priority to 202111154399.5, filed on Sep. 29, 2021, in the Chinese Intellectual Property Office, the disclosures of which are incorporated by reference herein in their entireties.

### BACKGROUND

### Field

The disclosure relates to the technical field of artificial intelligence. More specifically, the disclosure relates to methods and devices for prediction model training and an information prediction.

### Description of the Related Art

Recently, with the improvement of users' security awareness, individual users pay more attention to the protection of personal privacy. Countries have also issued and formulated relevant laws and regulations to protect personal data and curb the abuse of personal information. Therefore, the protection and legal utilization of user data must be considered in artificial intelligence applications, including a user portrait system. In the user portrait system, the prediction of user attributes often needs to use all kinds of user data. However, these data often involve user privacy. The vast majority of existing user attribute prediction information systems need to collect and store these user data for prediction on the server. In this way, there is a great risk of user privacy disclosure and legal compliance.

### SUMMARY

Example embodiments of the disclosure aim at providing a prediction model training method and device and an information prediction method and device to improve accuracy of user attribute prediction.

According to an aspect of the disclosure, there is provided a prediction model training method, which is performed by a server, including: transmitting, to a plurality of training devices, a model to be trained by the plurality of training devices, wherein the model to be trained includes feature extraction layers configured to extract user features and prediction layers configured to perform information prediction; classifying the plurality of training devices into at least one group based on the user features extracted by the training devices; receiving, from the plurality of training devices, model parameters obtained by the respective training devices training the model to be trained, wherein the model parameters include first parameters corresponding to the feature extraction layers and second parameters corresponding to the prediction layers; performing global federated aggregation based on the first parameters to obtain a global federated aggregation result; performing intra-group federated aggregation for each of the at least one group, based on the second parameters of one or more of the plurality of training devices in a respective group, among each of the at least one group, to obtain an intra-group federated aggregation result; and transmitting, to each of the plurality of training devices, the global federated aggregation result and the intra-group federated aggregation result associated the respective group of the respective training device, so that the plurality of training devices update the first parameters of the feature extraction layers based on the global federated aggregation result and update the second parameters of the prediction layers based on the intra-group federated aggregation result.

The prediction model training method may include acquiring user device information from a plurality of user devices; and selecting the plurality of training devices from the plurality of user devices based on the user device information.

The transmitting the model to be trained to the training devices may include: transmitting first information corresponding to the feature extraction layers for extracting user features to the plurality of training devices; determining pre-trained groups of the plurality of training devices, respectively, based on a pre-trained grouping result; and transmitting, to the plurality of training devices, second information corresponding to the prediction layers based on the pre-trained groups.

The classifying the respective training devices into the at least one group may include: acquiring process capabilities of each of the plurality of training devices; and classifying the plurality of training devices into one or more groups among the at least one group based on the user features and the process capabilities of the plurality of straining devices.

The classifying the plurality of training devices into the at least one group may further include: clustering the plurality of training devices based on the user features of the respective training devices to obtain at least one first level group; and classifying, for each of the first level groups, the respective training devices based on the process capabilities of the respective training devices within the first level group to obtain at least one second level group, the obtained respective second levels of groups serving as a grouping result.

The performing global federated aggregation based on the first parameters of the respective training devices may include: weighted averaging the first parameters of the respective training devices to obtain the global federated aggregation result.

The performing intra-group federated aggregation on the second parameters of the respective training devices in the group in each of the at least one group may include: weighted averaging the second parameters of the respective training devices in the group in each of the at least one group to obtain the intra-group federated aggregation result.

The training method further may include updating the grouping result.

The updating the grouping result may include: calculating a similarity between each of the plurality of training devices and each of the at least one group, respectively; and updating the grouping result based on the similarity.

The prediction model may be configured to predict predicting user attribute information.

The prediction model training method may further include repeatedly performing the operations of: receiving the model parameter, performing the global federated aggregation and the intra-group federated aggregation, and transmitting the global federated aggregation result and the intra-group federated aggregation result until end of training.

According to another aspect of the disclosure, there is provided a prediction model training method, which is performed by a server, the method including: transmitting a model to be trained to a plurality of training devices, the model to be trained including feature extraction layers configured to extract user features and prediction layers configured to perform information prediction; classifying the plurality of training devices into at least one group based on the user features extracted by the plurality of training devices and transmitting a grouping result to the plurality of training devices; receiving model parameters obtained by the plurality of training devices training the model to be trained, wherein the model parameters include first parameters corresponding to the feature extraction layers; performing global federated aggregation on the first parameters of the respective training devices to obtain a global federated aggregation result; transmitting the global federated aggregation result to the plurality of training devices so that the plurality of training devices update the feature extraction layers based on the global federated aggregation result.

According to another aspect of the disclosure, there is provided a prediction model training method, which is performed by a server, including: receiving model parameters obtained by a plurality of training devices in a first group, among at least one group, training the model to be trained, the model to be trained including feature extraction layers configured to extract user features and prediction layers configured to perform information prediction, and the model parameters include second parameters corresponding to the prediction layers; performing intra-group federated aggregation on the second parameters of the plurality of training devices in the first group to obtain an intra-group federated aggregation result; and transmitting the intra-group federated aggregation result to the plurality of training devices in the first group so that the plurality of training devices update the prediction layers based on the intra-group federated aggregation result.

According to another aspect of the disclosure, there is provided a prediction model training method, which is performed by a training device, the method including: receiving a model to be trained from a server, the model to be trained including feature extraction layers configured to extract user features and prediction layers configured to information prediction; extracting a user feature using the feature extraction layers in the model to be trained, and transmitting the extracted user feature to the server to classify the training device into one of at least one group based on the user features; training the model to be trained, and transmitting model parameters obtained by training to the server, wherein the model parameters include first parameters corresponding to the feature extraction layers and second parameters corresponding to the prediction layers; receiving a global federated aggregation result and an intra-group federated aggregation result from the server, wherein the global federated aggregation result is obtained by the server performing global federated aggregation on the first parameters of the respective training devices, and the intra-group federated aggregation result is obtained by the server performing intra-group federated aggregation on the second parameters of the respective training devices in the corresponding group; and updating the feature extraction layers based on the global federated aggregation result, and updating the prediction layers based on the intra-group federated aggregation result.

According to another aspect of the disclosure, there is provided an information prediction method, which is executed by a user device, the method including: receiving parameters of feature extraction layers of a prediction model and first central point information corresponding to a first group, among at least one group, the feature extraction layers configured to extract user features, and the first central point information representing an average user feature of user devices within the first group; obtaining the prediction model corresponding to the user device based on the feature extraction layers, the first central point information and user data of the user device; and predicting information using the obtained prediction model.

The prediction model training method and device according to the example embodiments of the disclosure reduce the accuracy loss in the process of federated learning and training and improve the accuracy of information prediction by the prediction model through federated learning based on the clustering and grouping aggregation. Here, federated learning and training may include, but is not limited to, a type a machine learning that is performed across multiple devices. According to some example embodiment, the federated learning may be considered as collaborative learning.

In addition, the prediction model training method and device according to the example embodiments of the disclosure enhance the accuracy of federated learning training of the prediction model and system availability by extracting and adding features of unstructured data.

Other aspects and/or advantages of an overall concept of the disclosure will be partially illustrated in the following description, and the rests will be clarified through description or implementation of an overall concept of the disclosure.

### BRIEF DESCRIPTION OF THE DRAWINGS

The above and other targets and characteristics of example embodiments of the disclosure will become apparent from the following description, taken in conjunction with the accompanying drawings illustrating embodiments by means of examples, in which:

FIG. 1A illustrates a flow diagram of a prediction model training method in accordance with an example embodiment of the disclosure;

FIG. 1B illustrates a diagram of classifying a training device in accordance with example embodiments of the disclosure;

FIG. 2 illustrates a flow diagram of a prediction model training method in accordance with another example embodiment of the disclosure;

FIG. 3 illustrates a flow diagram of a prediction model training method in accordance with another example embodiment of the disclosure;

FIG. 4 illustrates a flow diagram of a prediction model training method in accordance with another example embodiment of the disclosure;

FIG. 5A illustrates a training process of a training system of a prediction model in accordance with example embodiments of the disclosure;

FIG. 5B illustrates a diagram of a server performing global federated aggregation and intra-group federated aggregation in accordance with example embodiments of the disclosure;

FIG. 5C illustrates a diagram of updating a grouping result in accordance with example embodiments of the disclosure;

FIG. 6 illustrates a flow diagram of an information prediction method in accordance with example embodiments of the disclosure;

FIG. 7 illustrates a diagram of extracting user behavior features in accordance with example embodiments of the disclosure;

FIG. 8 illustrates a diagram of extracting features from unstructured data in accordance with example embodiments of the disclosure;

FIG. 9 illustrates a prediction process of a user attribute prediction system in accordance with example embodiments of the disclosure;

FIG. 10 illustrates an example of device grouping in accordance with example embodiments of the disclosure;

FIG. 11 illustrates a flow diagram of a method for performing user attribute prediction by distinguishing types of devices in accordance with example embodiments of the disclosure;

FIG. 12 illustrates a block diagram of a prediction model training device in accordance with an example embodiment of the disclosure;

FIG. 13 illustrates a block diagram of a prediction model training device in accordance with another example embodiment of the disclosure;

FIG. 14 illustrates a block diagram of a prediction model training device in accordance with another example embodiment of the disclosure;

FIG. 15 illustrates a block diagram of a prediction model training device in accordance with another example embodiment of the disclosure;

FIG. 16 illustrates a block diagram of an information prediction device in accordance with example embodiments of the disclosure; and

FIG. 17 illustrates a diagram of a computing device in accordance with example embodiments of the disclosure.

### DETAILED DESCRIPTION

Now examples of the embodiments are illustrated in the drawings with detailed reference to example embodiments of the disclosure, wherein the same label consistently indicates the same component. The embodiments will be explained below by referring to the accompanying drawings to explain the disclosure.

Recently, with the rapid development of mobile Internet and the wide popularization of mobile intelligent terminals, mobile terminals have become the mainstream entrance of the Internet. Users produce a large amount of user data on various intelligent terminals every day. Since these user data often contain user preference information, they are widely used in various Internet services by various service providers, such as user portrait, personalized recommendation, personalized search and advertising push, etc. These services not only improve the user experience, but also bring a lot of business benefits and values to service providers. Therefore, performing deep mining on user data to improve service quality is a core business of service providers.

A user portrait, which can be regarded as virtual attribute representation of real users, was initially applied in the field of e-commerce. In the context of the big data era, each specific information of users can be abstracted into labels. The user image can be concretized by using the labels, or can be divided into different types according to the differences of users' behavior characteristics. Based on the differences of these labels or behavior types, targeted services can be provided for users to make the services more focused and personalized.

In the field of personalized recommendation, recommendation based on user statistical information is almost a recommendation method which is easiest to implement. The user statistical information may include user age, gender, occupation, marriage, education level, health level, income, etc. However, the disclosure is not limited thereto. According to an example embodiment, users are distinguished based on their age and gender, so as to make personalized recommendations for different types of users. However, user statistical information is difficult to obtain directly, at present, prediction technology is generally used to obtain basic demographic information such as a user's age and gender and the like. The above user statistical information may also be called user demographic information or user attribute information.

User privacy may be protected through federated learning. In federated learning, the same initial model is deployed to all devices selected by a server to participate in training. On each device, user data is stored locally and is not uploaded to the server. If the trained model is a prediction model for predicting user attribute information, the user data may include user population attributes, interest tags, and user historical usage data, etc. In the federated training phase, the model with the same initialization structure and parameters is locally trained independently on each device at the same time, thereby protecting the data privacy. In each training cycle t, when the local model wₜ^{k}, trained by device k, is trained for complete m local iterations, only the intermediate results in the training process are interactive. For example, model parameters such as gradient or weight are uploaded to the server and the server conducts average aggregation for the intermediate parameters wₜ^{k} of the received models of each device, and updates a global federated model (also known as a global model) Wt thereby obtaining a global federated model Wt+1 in the cycle t+1. The server transmits this global federated model as updated information to the respective devices participating in the training. At the end of each training cycle, each device participating in the training updates the local model after receiving a global model weight Wt+1, and then continues the federated training until the condition for stopping the training is reached. In the prediction stage, the server pushes the trained unique global model to all devices for prediction. Each device uses trained models and local data to predict, for example, a user's age, gender, interest tags, etc.

In the process of federated learning, 1) independent training is conducted on each distributed device; and 2) the received model parameters are aggregated and simply averaged. This applies when the data distribution between devices is similar. However, in the federated learning method, a user corresponding to the device may have very different characteristics and behavior patterns. Simple aggregation-average may reduce the accuracy of federated learning and make the prediction accuracy of the prediction model obtained based on federated learning training low. In addition, only structured data is used for prediction in a prediction task (such as a task of predicting user attribute information), but unstructured data information is not used, so that the extracted user features are not comprehensive, which also affects the prediction accuracy of the prediction model.

Specifically, user data does not follow the same distribution principle on each device, but often has extremely different behavior and distribution characteristics. The models trained on different devices are more suitable for the local behavior data distribution of the devices. If a global model is obtained by simply aggregation-averaging the model parameters of the respective devices in each federated training cycle, the simple aggregated global model on different data distributions is not suitable for the data distribution of independent devices and may not generate a global model suitable for all the devices. For example, different user groups have different behavior data distribution. For example, urban teenagers may have different behavioral data distribution than adult blue collar workers.

In independent distributed training, the associated user behavior patterns will bring noise signals to the behavior data of users with different characteristics. For example, an application has associated usage patterns in user groups with different characteristics. For example, in a period of continuous promotion activities of a certain shopping application, the usage frequency and duration of the application will increase in relevance in different user groups. These associated behavior patterns will not be recognized as signals with large amount of information in a task of, for example, predicting user attributes. However, independent devices can only use limited local data in the training during the distributed federated training, as a result, the local model of independent training may mistakenly believe that the above behavior patterns are highly correlated signals, therefore, a global model obtained by aggregating and averaging the distributed model parameters by traditional federated learning may incorrectly identify these noise signals, affect the prediction accuracy of the prediction model, and make the accuracy of prediction tasks (such as predicting a gender, age, income, etc.) low.

In addition, if the same model is deployed on the devices for prediction model training, but the process capability of each device is different, in order to enable all the respective devices to be trained, a prediction model with lower performance may be deployed on the respective devices to adapt to devices with lower process capability, which leads to the low prediction accuracy of the prediction model.

In addition, unstructured data information is not used in the prediction process, resulting in low prediction accuracy. Structured data may include names and simple interpretable values, for example, application program ID, user ID, sleeping time, application usage time, etc. However, unstructured data information does not have a certain number of values that can be directly explained, and may include some search records, short messages, etc. The unstructured data information plays a very important role in predicting user attribute information. For example, in order to establish a user portrait for a user's age and gender, for the search record data of a man around 30 years old, some of the content (such as “wife, electric shaver”) are relatively important information. If the information are not used for prediction, the prediction accuracy of the prediction model will be low.

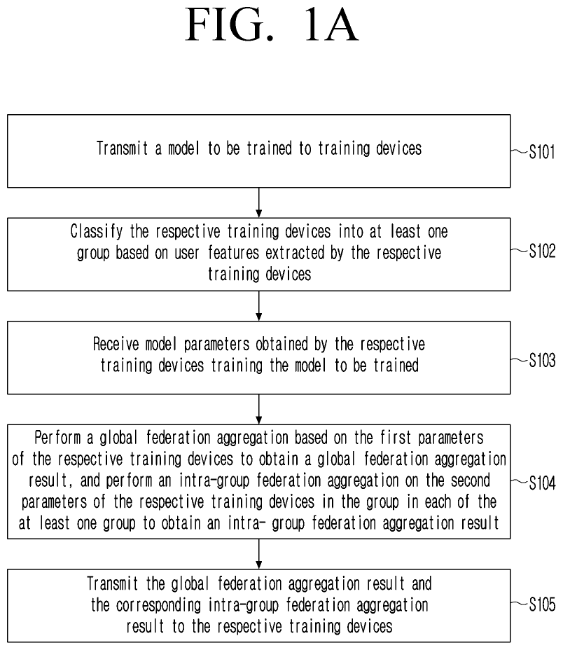

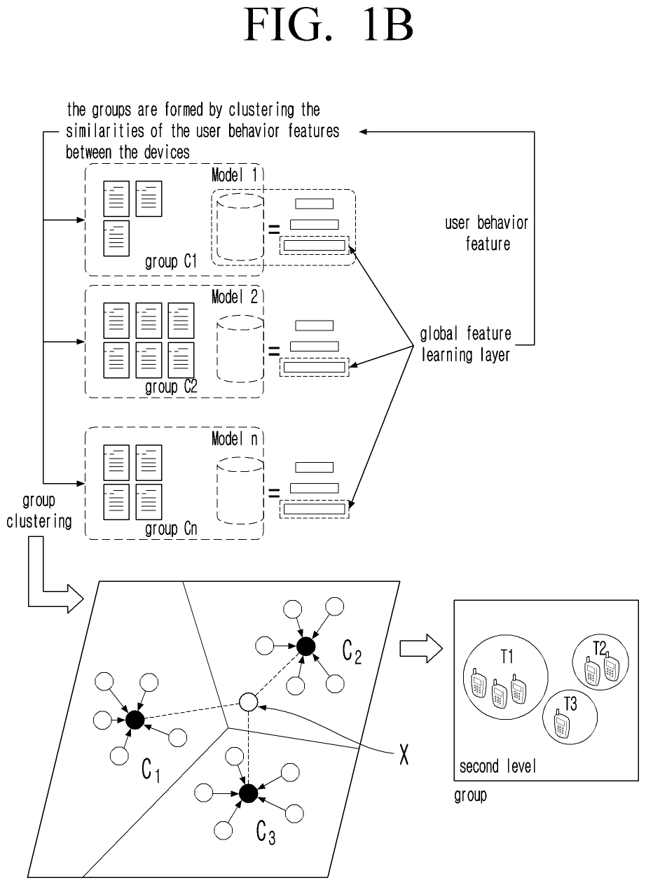

FIG. 1A illustrates a flow diagram of a prediction model training method in accordance with an example embodiment of the disclosure. The prediction model training method in FIG. 1A may be performed by a server. The server may include a memory storing one or more instructions and a processor configured to execute the one or more instructions to the prediction model training method. The server may be referred to as a global server or a first server. FIG. 1B illustrates a diagram of classifying training devices in accordance with example embodiments of the disclosure.

Referring to FIG. 1A, at S101, a model to be trained is transmitted to training devices. Here, the model to be trained includes feature extraction layers for extracting user features and prediction layers for performing information prediction. Here, user features may include user behavior features. For example, user features may be behavior features of users using a user device. The feature extraction layers may be, for example, global feature learning layers (GFLL), and the prediction layers may be, for example, cluster prediction layers (ICPL). The model to be trained may be obtained by the server through pre-training or random initialization.

In the example embodiments of the disclosure, before transmitting the model to be trained to the training devices, the server may firstly acquire user device information transmitted by the user devices and then select the training devices from the user devices based on the user device information. Here, the user device information includes at least one of user behavior data amount, device power consumption, network link status, data rate, whether being connected to a charger. That is, the server may decide whether a user device participates in the training according to user device information. In addition, the user device information may further include processing capacity information or processing resource information. For instance, the user device information may include information about memory, chipset, Central Processing Unit (CPU), Tensor Processing Unit (TPU), Neural Processing Unit (NPU), Graphics Processing Unit (GPU) and/or a Digital Signal Processor (DSP).

In the example embodiments of the disclosure, if the model to be trained is obtained by the server through the pre-training, when transmitting the model to be trained to the training devices, the server may first transmit the parameters of the feature extraction layers for extracting user features to the training devices, determine the pre-trained groups corresponding to the respective training devices based on the pre-training grouping result, respectively, and then transmit the parameters of the prediction layers corresponding to the pre-trained groups corresponding to the respective training devices to the respective training devices, respectively.

According to an example embodiment, when the pre-trained groups corresponding to the respective training devices are determined, respectively, the first similarity between the user features of the respective training devices and the central points of the respective pre-trained groups may be first calculated, respectively, and then a pre-trained group having the maximum first similarity in the respective pre-trained groups is determined as a pre-trained group corresponding to the respective training devices, respectively.

In another example embodiment, when the pre-trained groups corresponding to the respective training devices are determined, respectively, the second similarity between user features of the respective training devices and the central points of the respective pre-trained groups may be first calculated, respectively, and then a pre-trained group having the maximum second similarity in the respective pre-trained groups is determined as a pre-trained group corresponding to the respective training devices, respectively.

Compared with the data of the training device, the user features (or the user behavior feature in the user features) has a lower dimension, and is obtained by splicing the features extracted from different types of data. The user features information is a concise and accurate representation of the user behavior for a certain target prediction task.

At S102, the respective training devices are classified into at least one group based on the user features extracted by the respective training devices.

In the example embodiments of the disclosure, when classifying respective training devices into at least one group, process capabilities of the respective training devices may be first acquired and then the respective training devices are classified into at least one group based on the user features and process capabilities of the respective training devices.

In the example embodiments of the disclosure, when classifying the respective training devices into at least one group based on the user features and process capabilities of the respective training devices, the respective training devices may be first clustered based on the user features of the respective training devices to obtain at least one first level group, and then for each of the first level groups, the respective training devices are classified based on the process capabilities of the respective training devices within the first level group, respectively, to obtain at least one second level group, and the obtained respective second levels of groups serve as a grouping result.

For example, as illustrated in FIG. 1B, the training devices may be first clustered into group C1, group C2, group C3, . . . , and group Cn based on the user behavior features, and the groups are formed by clustering the similarities of the user behavior features between the devices. For each group, the corresponding prediction model may be obtained by training, as illustrated in the figures, the models are Model 1, Model 2, . . . , and Model n, respectively, wherein the prediction model includes a global feature learning layers and an cluster prediction layers, the respective groups correspond to the same global feature learning layers, different groups correspond to different cluster prediction layers, and the user behavior features are obtained by extracting based on the global feature learning layers. Then the training devices in each group are second-level grouped or classified according to the process capabilities of the training devices in each group (which may be called a first level group), for example, second levels of groups (which may also be called a second level group) T1, T2 and T3 in FIG. 1B.

At S103, model parameters obtained by the respective training devices training the model to be trained is received. Here, the model parameters include first parameters corresponding to the feature extraction layers and second parameters corresponding to the prediction layers.

According to an example embodiment, intermediate results are obtained after the respective training devices train the models to be trained, for example, model parameters, such as gradient or weight, wherein they include the first parameters of the feature extraction layers and the second parameters corresponding to the prediction layers. The respective training devices transmit the intermediate results obtained by training to the server for aggregation.

At S104, global federated aggregation is performed based on the first parameters of the respective training devices to obtain a global federated aggregation result, and intra-group federated aggregation is performed on the second parameters of the respective training devices in the group in each of the at least one group to obtain an intra-group federated aggregation result.

In the example embodiments of the disclosure, when global federated aggregation is performed based on the first parameters of the respective training devices, the first parameters of the respective training devices may be weighted averaged to obtain the global federated aggregation result. That is, aggregation learning is performed for the feature extraction layers among all the training devices participating in the training (including all groups of training devices), so that the user features calculated using the feature extraction layers have the consistent global standard.

In the example embodiments of the disclosure, when intra-group federated aggregation is performed on the second parameters of the respective training devices in the group in each of the at least one group, the second parameters of the respective training devices in the group in each of the at least one group may be weighted averaged to obtain the intra-group federated aggregation result. That is, the prediction layers is trained within the group obtained in each cluster, respectively. Low performance device groups may use prediction layers with low complexity and low requirements for hardware computing performance.

At S105, the global federated aggregation result and the corresponding intra-group federated aggregation result are transmitted to the respective training devices, so that the training devices update the parameters of the feature extraction layers based on the global federated aggregation result and update the parameters of the prediction layers based on the intra-group federated aggregation result.

In the example embodiments of the disclosure, after the global federated aggregation result and a corresponding intra-group federated aggregation result are transmitted to the respective training devices, the grouping result may be further updated to transmit the updated grouping result to the respective training devices.

In the example embodiments of the disclosure, when the grouping result is updated, similarities between the respective training devices and each of the at least one group may be first calculated, respectively, and then the grouping result is updated based on the similarities.

In the example embodiments of the disclosure, when the grouping result is updated based on the similarities, when the similarity between a first training device and the group to which the first training device belongs is less than the similarity between the first training device and at least one remaining group in the at least one group, a group having the maximum similarity with the one training device may be selected from the remaining groups in the at least one group, and then the selected group is updated to be a group of the first training device.

In the example embodiments of the disclosure, the prediction module may be used for predicting user attribute information.

In the example embodiments of the disclosure, after S105, the server may repeatedly perform the receiving the model parameter, the global federated aggregation and the intra-group federated aggregation, and the transmitting the global federated aggregation result and the intra-group federated aggregation result until the training ends.

The embodiments of the present application propose that a global server (which may be called a first server) and a plurality of group servers (which may be called a second server) may be disposed, the global server is responsible for determining groups, global federated aggregation is performed for the first parameters corresponding to the feature extraction layers of the respective training devices, one or more groups may correspond to one group server, and the group server is responsible for performing intra-group federated aggregation for the second parameters corresponding to the prediction layers of the respective training devices within the group.

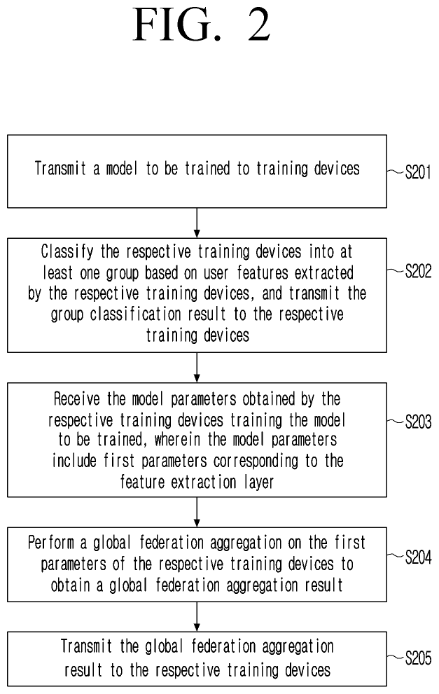

FIG. 2 illustrates a flow diagram of a prediction model training method in accordance with another example embodiment of the disclosure.

The prediction model training method in FIG. 2 may be performed by a global server.

Referring to FIG. 2, at S201, a model to be trained is transmitted to training devices. Here, the model to be trained includes feature extraction layers for extracting user features and prediction layers for performing information prediction. Here, user features may be behavior features of users using the device, for example, may include user behavior features. The feature extraction layers may be, for example, global feature learning layers (GFLL), and the prediction layers may be, for example, cluster prediction layers (ICPL). The model to be trained may be obtained by the global server through pre-training or random initialization.

In the example embodiments of the disclosure, the global server may first obtain user device information transmitted by the user device before transmitting the model to be trained to the training devices, and then select the training devices from the user devices based on the user device information. Here, the user device information includes at least one of user behavior data amount, device power consumption, network link status, data rate, whether being connected to a charger. That is, the global server may decide whether a user device participates in the training according to user device information. However, the disclosure is not limited thereto, and as such, according another example embodiment, the global server may transmit the model to be trained to the training devices before obtaining user device information transmitted by the user device or without obtaining user device information transmitted by the user device. According to this example embodiment, the global server may make further modifications based the received user device information. For example, the global server may update the model to be trained based the received user device information.

In the example embodiments of the disclosure, if the model to be trained is obtained by the global server through the pre-training, when transmitting the model to be trained to the training devices, the global server may first transmit the parameters of the feature extraction layers for extracting user features to the training devices, determine the pre-trained groups corresponding to the respective training devices based on the pre-trained grouping result, respectively, and then transmit the parameters of the prediction layers corresponding to the pre-trained groups corresponding to the respective training devices to the respective training devices, respectively.

According to an example embodiment, when the pre-trained groups corresponding to the respective training devices are determined, respectively, the first similarity between the user features of the respective training devices and the central points of the respective pre-trained groups may be first calculated, respectively, and then a pre-trained group having the maximum first similarity in the respective pre-trained groups is determined as a pre-trained group corresponding to the respective training devices, respectively.

In another example embodiment, when the pre-trained groups corresponding to the respective training devices are determined, respectively, the second similarity between user features of the respective training devices and the central points of the respective pre-trained groups may be first calculated, respectively, and then a pre-trained group having the maximum second similarity in the respective pre-trained groups is determined as a pre-trained group corresponding to the respective training devices, respectively.

At S202, the respective training devices are classified into at least one group based on the user features extracted by the respective training devices, and the grouping result is transmitted to the respective training devices. Here, the grouping result includes at least one of a group to which the training devices belong, central point information of the group to which the training devices belong and server information of the group to which the training devices belong. Here, the central point information represents an average user feature of the respective training devices within the group and a server of the group to which the training devices belong is used for performing intra-group federated aggregation on the second parameters transmitted by the respective training devices within the group.

In the example embodiments of the disclosure, the global server may first obtain process capabilities of the respective training devices when the global server classifies the respective training devices into at least one group, and then classify the respective training devices into at least one group based on the user features and process capabilities of the respective training devices.

In the example embodiments of the disclosure, when the global server classifies the respective training devices into at least one group based on the user features and process capabilities of the respective training devices, it may first cluster the respective training devices based on the user features of respective training devices to obtain at least one first level group, then for each of the first level groups, classify the respective training devices based on the process capabilities of the respective training devices within the first level group, respectively, to obtain at least one second level group, and use the obtained respective second levels of groups as a grouping result.

At S203, model parameters obtained by the respective training devices training the model to be trained are received. Here, the model parameters include first parameters corresponding to the feature extraction layers.

At S204, global federated aggregation is performed on the first parameters of the respective training devices to obtain a global federated aggregation result.

In the example embodiments of the disclosure, when the global server performed global federated aggregation based on the first parameters of the respective training devices, it may weighted average the first parameters of the respective training devices to obtain the global federated aggregation result.

At S205, the global federated aggregation result is transmitted to the respective training devices so that the training devices update the feature extraction layers based on the global federated aggregation result.

In the example embodiments of the disclosure, after the global server transmits the global federated aggregation result and a corresponding intra-group federated aggregation result to the respective training devices, it may further update the grouping result to transmit the updated grouping result to the respective training devices.

In the example embodiments of the disclosure, when the global server updates the grouping result, it may first calculate similarities between the respective training devices and each of the at least one group, respectively, and then update the grouping result based on the similarities.

In the example embodiments of the disclosure, when the global server updates the grouping result based on the similarities, when the similarity between one training device and the group to which the one training device belongs is less than the similarity between the one training device and at least one remaining group in the at least one group, it may select a group having the maximum similarity with the one training device from the remaining groups in the at least one group, and then update the selected group to be a group of the one training device.

In the example embodiments of the disclosure, the prediction module may be used for predicting user attribute information.

In the example embodiments of the disclosure, after S205, the global server may repeatedly perform S203 to S205 until the training ends.

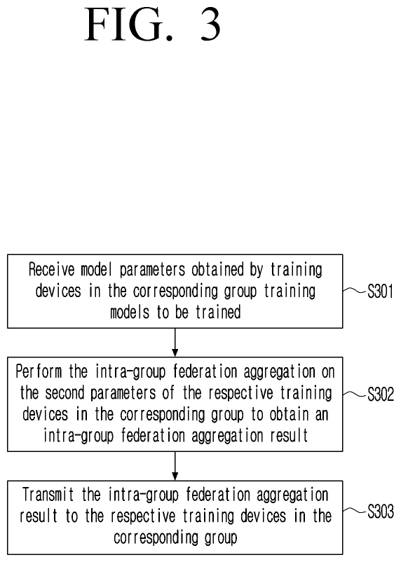

FIG. 3 illustrates a flow diagram of a prediction model training method in accordance with another example embodiment of the disclosure. The prediction model training method in FIG. 3 may be performed by a group server.

Referring to FIG. 3, at S301, the group server receives model parameters obtained by training devices in the corresponding group training models to be trained. Here, the model to be trained includes feature extraction layers for extracting user features and prediction layers for performing information prediction. The model parameters include second parameters corresponding to the prediction layers.

At S302, intra-group federated aggregation is performed on the second parameters of the respective training devices in the corresponding group to obtain an intra-group federated aggregation result.

In the example embodiments of the disclosure, when the group server performs intra-group federated aggregation on the second parameters of the respective training devices in the group in each of the at least one group, it may weighted average the second parameters of the respective training devices in the group in each of the at least one group to obtain the intra-group federated aggregation result.

At S303, the intra-group federated aggregation result is transmitted to the respective training devices in the corresponding group so that the training devices update the prediction layers based on the intra-group federated aggregation result.

In the example embodiments of the disclosure, the prediction module may be used for predicting user attribute information.

In the example embodiments of the disclosure, after S303, the group server may repeatedly perform S301 to S303 until the training ends.

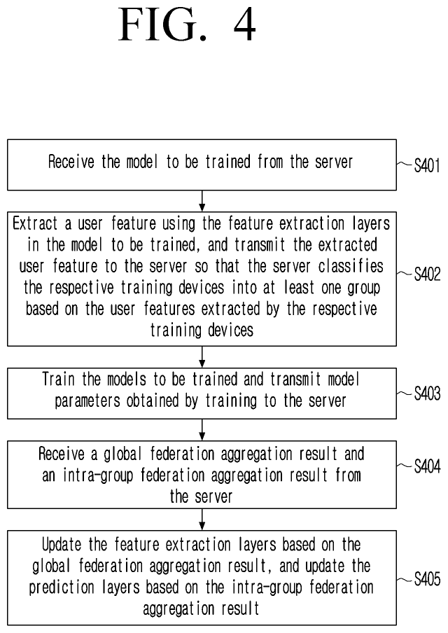

FIG. 4 illustrates a flow diagram of a prediction model training method in accordance with another example embodiment of the disclosure. The prediction model training method in FIG. 4 may be performed by a training device.

Referring to FIG. 4, at S401, the model to be trained is received from the server. Here, the model to be trained includes feature extraction layers for extracting user features and prediction layers for performing information prediction.

In the example embodiments of the disclosure, when the training device receives the model to be trained from the server, it may first receive parameters of the feature extraction layers for extracting user features from the server, and then receive the prediction layers parameters corresponding to the group to which the training device belongs from the server. Here, the prediction layers parameters corresponding to the group to which the training device belongs is determined by the server from parameters of the respective prediction layers obtained by pre-training based on the grouping result.

At S402, a user feature is extracted using the feature extraction layers in the model to be trained, and the extracted user feature is transmitted to the server so that the server may classify the respective training devices into at least one group based on the user features extracted by the respective training devices.

At S403, the models to be trained are trained and model parameters obtained by training are transmitted to the server. Here, the model parameters include first parameters corresponding to the feature extraction layers and second parameters corresponding to the prediction layers.

According to an example embodiment of the disclosure, the server may use a first server and a second server. For example, when the training device transmits the model parameters obtained by training, the training device may first receive the grouping result transmitted by a first server, transmit the first parameters in the model parameter to the first server and then determine second server information of the group to which the training device belongs based on the grouping result to transmit the second parameters in the model parameters to a second server identified by the second server information.

In the example embodiments of the disclosure, when the training device receives the global federated aggregation result and the intra-group federated aggregation result from the server, training device may receive the global federated aggregation result from the first server, and receive the intra-group federated aggregation result from the second server.

In the example embodiments of the disclosure, the grouping result may include at least one of a group to which the training device belongs, central point information of a group to which the training device belongs and server information of a group to which the training device belongs. Here, the central point information represents an average user feature of the respective training devices within the group.

At S404, a global federated aggregation result and an intra-group federated aggregation result are received from the server, wherein the global federated aggregation result is obtained by the server performing global federated aggregation on the first parameters of the respective training devices, and the intra-group federated aggregation result is obtained by the server performing intra-group federated aggregation on the second parameters of the respective training devices in the corresponding group.

At S405, the feature extraction layers is updated based on the global federated aggregation result, and the prediction layers is updated based on the intra-group federated aggregation result.

In the example embodiments of the disclosure, the prediction module may be used for predicting user attribute information.

In the example embodiments of the disclosure, after S405, the training device may repeatedly perform S403 to S405 until the training ends.

The prediction model training method proposed by the present application classifies the devices used by a user into a plurality of groups using layered prediction models (LPM).

A clustering algorithm learns to extract user behavior features (UBF) through the GFLL and then defines similarity of user behaviors, thereby clustering the user devices having the similar user behavior features in the group. Meanwhile, a computing processing capability of a device may be further considered while classifying groups.

Regarding the groups obtained by the clustering, a plurality of correct group prediction models rather than only one general global model are learned. Meanwhile, the independent distributed training model is prevented from learning the wrong signals caused by the correlation behavior between different user characteristic groups through the clustering of user devices.

The input of the ICPL in the prediction model is the user behavior features and the output represents a prediction result vector. A corresponding exclusive model is trained within each group, meanwhile, a computing processing capability of a device may be further considered, for example, low performance device groups may use prediction models with low complexity and low requirements for hardware computing performance. In each federated training cycle, the GFLL uses a global federated aggregation parameter, and the ICPL uses an intra-group federated aggregation parameter.

The federated learning method based on clustering and hierarchical aggregation proposed in the embodiments of the application reduces the accuracy loss in the traditional federated learning training process and improves the prediction accuracy of the prediction model under the common situation of diversified and relevant distribution of user behavior data.

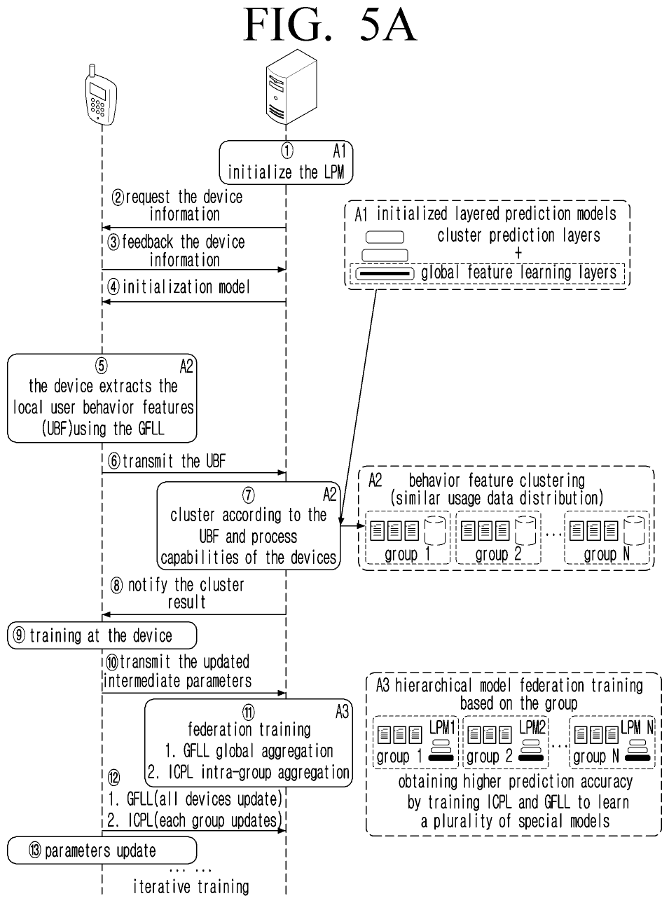

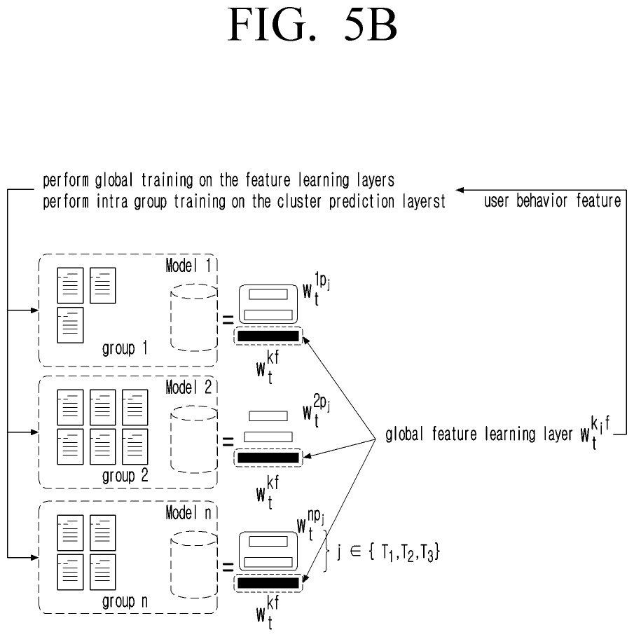

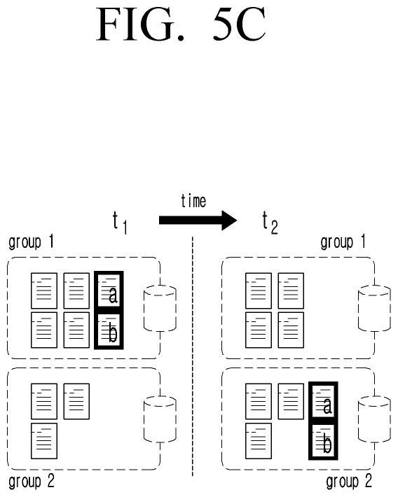

FIG. 5A illustrates a training process of a training system of a prediction model in accordance with example embodiments of the disclosure. A hierarchical prediction model (LPM) is used as a prediction model in FIG. 5A. The hierarchical prediction model includes global feature learning layers (GFLL) and cluster prediction layers (ICPL). FIG. 5B illustrates a diagram of a server performing global federated aggregation and intra-group federated aggregation in accordance with example embodiments of the disclosure. FIG. 5C illustrates a diagram of updating a grouping result in accordance with example embodiments of the disclosure.

As illustrated in FIG. 5A, a training system of a prediction model (for example, a user attribute prediction model) includes a server and a plurality of devices. At operation \textcircled{1}, the server uses the hierarchical prediction model (LPM) obtained by pre-training as an initialization model, or the server may determine the weight of the hierarchical prediction model (LPM) through random initialization to obtain the initialization model.

At operation \textcircled{2}, the server requests (or queries) the information of the devices (including, for example, but not limited to, user ID, device ID, device model configuration, etc.).

At operation \textcircled{3}, the devices return the queried information. Here, the device returns the queried information as feedback information.

At operation \textcircled{4}, the server determines the devices participating in the training according to the information returned by the devices, and transmits the initialization model (or an initial model parameter) to the devices participating in the training.

At operation \textcircled{5}, the devices participating in the training use global feature learning layers in the initialization model and extract the local user behavior features (UBF) from the local user data. According to an example embodiment, the devices may extract the local user behavior features (UBF) from the local user data using the GFLL.

The devices participating in the training use the global feature learning layers in the initialization model to predict the user behavior features of the training devices based on the data (the user behavior data) of the training devices. For example, the devices participating in the training maps the input D-dimensional user behavior data RD to the behavior features (UBF) of the B-dimensional user xi through the global feature learning layers with parameter weight ø: f_{ø}(xᵢ): R^{D}→R^{B}.

At operation \textcircled{6}, the devices participating in the training transmit the extracted user behavior feature to the server.

At operation \textcircled{7}, the server clusters the respective devices participating in the training according to the UBF and process capabilities fed back by the respective devices participating in the training to obtain a plurality of groups. The respective devices participating in the training in each group have similar UBF (that is, similar usage data distribution) and similar process capability. The process capabilities of the devices may be obtained from the device information.

For example, the server may first classify the devices participating in the training into the first level group according to the UBF. The first level group may further be divided into a second level group by the process capability of the devices (for example, high performance type T1, and low performance type T2). Performance types are generally coarse-grained performance indicators, for defining devices in an unified performance type have similar computing process capabilities, especially the capabilities to run AI applications and neural networks with similar complexity. In fact, AI applications such as smart cameras and editors often design AI modules with different complexity on different performance types of hardware. Performance types may be classified by testing AI application delay and other indicators; or may be calculated by the configuration of the device's memory, CPU, GPU, NPU or other computing chips. The cluster prediction layers may be designed with a variety of complexity and accuracy for different performance types. For example, for high-performance types, a 6-layer perceptron (MLP) or an MLP mixer network is used; a 3-layer perceptron is used for ordinary performance types; and single layer neurons or linear prediction layers are used for low performance types.

In the example embodiments of the disclosure, the model may be customized to make full use of the performance of an apparatus, the device with high process capability uses an accurate artificial intelligence model, and the device with low process capability may use the device with low accuracy, thereby sufficiently utilizing process capabilities of the respective devices and implementing the personalized customization of the model.

When the server classifies the devices participating in the training into the first level group according to the UBF, it may first calculate two important clustering parameters through the UBF;

(1) the central point of group k, which represents the average user behavior feature of all devices within the group, it is assumed that group k has {Sk} users, then the central point ck may be defined as predicting

$${c}_{k} = \frac{1}{\vert {S}_{k} \vert} {\sum }_{{x}_{i} ∈ {S}_{k}} {f}_{∅} ( {x}_{i} ) ;$$

and

(2) a similarity between device x and group k (for example, normalized similarity). The similarity

$${p}_{ϕ} ( y = k \vert x ) = \frac{exp ( - d ( {f}_{ϕ} ( x ) , {c}_{k} ) )}{{\sum }_{{k}^{′}} exp ( - d ( {f}_{ϕ} ( x ) , {c}_{{k}^{′}} ) )}$$

may be calculated by the softmax function of cosine similarity d(fϕ(x), ck)).

The server may then group using a clustering algorithm (e.g., k-means learning). The number n of the groups needs to balance the quality and efficiency of clustering, and n gradually increases until the ratio of the variance in the group to the variance of all user devices and the similarities of devices within the group within and outside the group all converge to a stable value.

At operation \textcircled{8}, the server feedbacks the result about the clustering (including group server information, central point in a group, etc.) for subsequent training.

At operation \textcircled{9}, according to the result about the clustering and the received initialization model, the device participating in the training performs iterative training locally.

At operation \textcircled{10}, after the devices participating in the training are trained to the preset round, the intermediate parameters are sent to the global server and the present group server for aggregation. Here, the global server and the present group server may be the same server, and may also be different servers. For example, one global server and one group server. For example, one global server and multiple group servers, and one or more groups use one group server. For example, one server performs the function of a global server and also acts as a group server for part of groups, and one or more group servers as group servers for the remaining part of groups.

All devices participating in the training perform independent training locally to ensure that the data does not leave the device, so as to protect data privacy. In each federated training cycle t, as shown in FIG. 5B, after the device ki in group k trains the model wₜ^{ki} locally for e rounds, only the intermediate results (model parameters such as gradient or weight) are transmitted to the server.

At operation C), the server performs global federated aggregation (which may be called global training) and intra group federated aggregation (which may be called intra group training) on the global feature learning layers and the cluster prediction layers, respectively (as shown in FIG. 5B).

A global feature learning layers wₜ^{kif} (or wₜ^{kf}) is aggregated in the global federation (f represents the feature). A global server uses simple weighted average aggregation (for example,

$${\sum }_{k = 1}^{K} {\sum }_{i = 1}^{\vert k \vert} \frac{{n}_{K}}{N} {w}_{t + 1}^{{k}_{i} f} \to {w}_{t + 1}^{f} )$$

to aggregate the global feature learning layers wₜ₊₁^{kif} of the models received from all the devices participating in the training into a global federated model wₜ₊₁^{f}, and transmits the global federated model wₜ₊₁^{f} as the updated result to all the devices participating in the training.

Intra group federated aggregation is performed on the cluster prediction layers wₜ^{kipj} (p represents prediction, wₜ^{kipj} may also be wₜ^{kpi}). In group k obtained by the clustering, the models of the devices are trained and aggregation-averaged. Assuming that the model of process performance type j is used, the server of the group aggregates the received cluster prediction layers model update, and calculates the aggregated cluster prediction layers model weight wₜ₊ᵢ^{kpi} using federated average (for example,

$${\sum }_{i = 1}^{\vert k \vert} \frac{{n}_{{k}_{i}}}{{N}_{k}} {w}_{t + 1}^{{k}_{i} {p}_{j}} \to {w}_{t + 1}^{{kp}_{j}} ) .$$

Here, j may belong to a second level group {T1, T2, T3}.

At operation \textcircled{12}, the server transmits the intermediate parameter obtained at operation \textcircled{11} to the devices participating in the training.

At operation \textcircled{13}, the devices participating in the training update a local model and continue training.

In each federated training cycle t, each device updates the local model according to the model parameters received from the server, wₜ₊₁=(wₜ₊₁^{kp}, wₜ₊₁^{f}), checks the updated cluster (after the update, a device may move to a new group) and continues training until the server ends the training according to a termination condition.

When the updated cluster is checked, the similarity between each device and the group is recalculated. When the new similarity of a device is closer to another group and the difference between this distance and the distance away from the original group is greater than a threshold, the cluster group may be updated. As illustrated in FIG. 5C, at time t1, device a and device b are classified into group 1 by clustering. After one or more training cycles, device a and device b are classified into group 2 by updating the clustering at time t2.

The example embodiments of the disclosure may obtain higher prediction accuracy by training ICPL and GFLL to learn a plurality of special models.

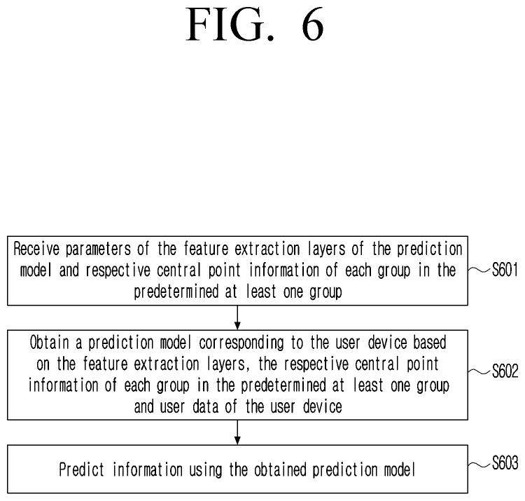

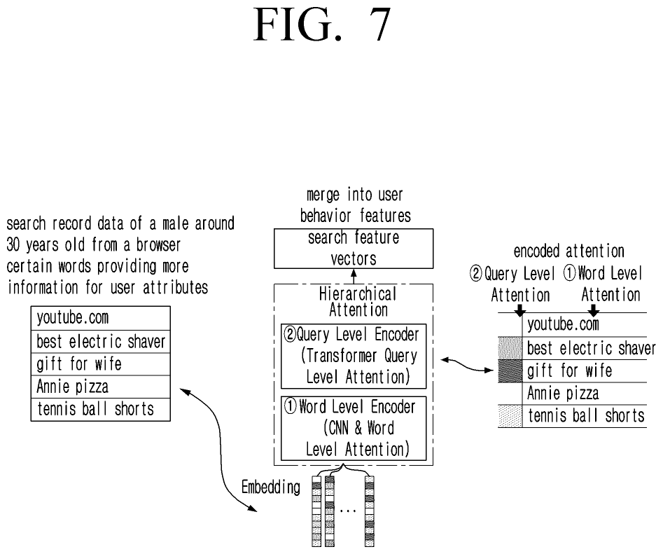

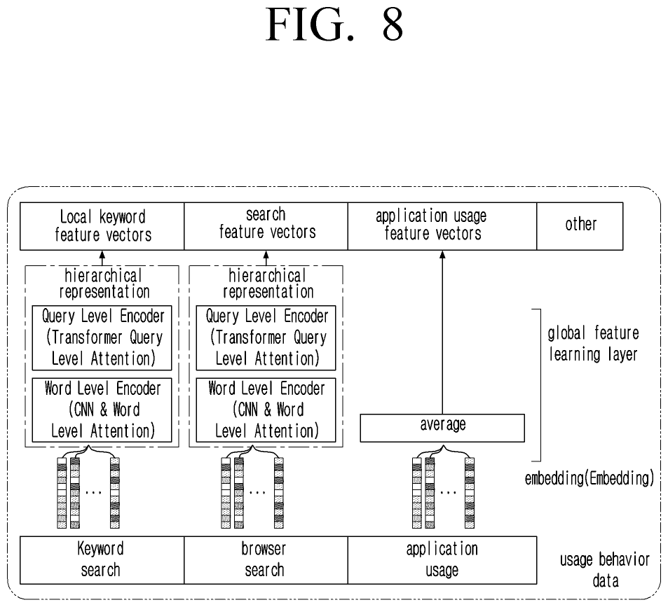

FIG. 6 illustrates a flow diagram of an information prediction method in accordance with example embodiments of the disclosure. The information prediction method in FIG. 6 may be performed by the user device. FIG. 7 illustrates a diagram of extracting user behavior features in accordance with example embodiments of the disclosure. FIG. 8 illustrates a diagram of extracting features from unstructured data in accordance with example embodiments of the disclosure.

The example embodiments of the disclosure propose that extracting important features in unstructured data enhances the accuracy of federated learning and training of a user attribute prediction model and the availability of the system. The features of unstructured data need to be learned and extracted (for example, feature extraction is performed at different levels based on a hierarchical attention method, respectively, such as learning and extracting important information in unstructured data from word level and higher level), and then combined with other ordinary features (such as features extracted from structured data) for prediction. The prediction model may extract important information from unstructured data to predict user age and gender, etc.

At S601, parameters of the feature extraction layers of the prediction model and respective central point information of each group in the predetermined at least one group are received. Here, the feature extraction layers is used for extracting user features, and the central point information represents an average user feature of the respective user devices within the group.

At S602, a prediction model corresponding to the user device is obtained based on the feature extraction layers, the respective central point information of each group in the predetermined at least one group and user data of the user device.

In the example embodiments of the disclosure, when the user device obtains the prediction model corresponding to the user device based on the feature extraction layers, the respective center point information of each group in the predetermined at least one group, and the user data of the user device, it may first extract user features from the user data of the user device using the feature extraction layers and then determine a prediction model corresponding to the user device based on the user features and the respective central point information of each group in the predetermined at least one group.

In the example embodiments of the disclosure, when the user device determines a prediction model corresponding to the user device based on the user features and the respective central point information of each group in the predetermined at least one group, it may first select a group from the predetermined at least one group based on the user features and the respective central point information of each group in the predetermined at least one group and then receive a prediction model corresponding to the selected group among the predetermined at least one prediction model as the determined prediction model corresponding to the user device.

In the example embodiments of the disclosure, when the user device selects a group from the predetermined at least one group based on the user features and the respective central point information of each group in the predetermined at least one group, it may first calculate the similarity between the user features and the respective central point information of each group in the predetermined at least one group, select the group with the maximum similarity from the predetermined at least one group as a first level group, acquire the process capability of the user device, and then select a second level group from the first level group based on the process capability, and use the selected second level group as the selected group.

In the example embodiments of the disclosure, when the user device determines the prediction model corresponding to the user device based on the user features and the respective central point information of each group in the predetermined at least one group, it may first calculate the similarity between the user features and the respective central point information of each group in the predetermined at least one group, select the groups with the maximum similarity and less than or equal to the preset number from the predetermined at least one group when all the calculated similarities are less than the threshold, and then determine the prediction models corresponding to the selected groups as the prediction models corresponding to the user device.

In the example embodiments of the disclosure, when the user device extracts the user features from the user data of the user device using the feature extraction layers, it may first extract a first user feature from the unstructured data in the user data, extract a second user feature from the structured data in the user data, and then fuse the first user feature and the second user feature to obtain the user feature.

In the example embodiments of the disclosure, when the user device extracts the first user feature from the unstructured data in the user data, it may first extract a word level feature through a word level encoder for at least one unstructured data, extract a query text level feature through a query level encoder, and then obtain the first user feature corresponding to the unstructured data based on the word level feature and the query text level feature.

The useful information in unstructured data (for example, short messages, text search records and other data) needs to be transformed into behavior features representing user attributes through the learning according to the importance degree, and then may be combined with other ordinary features, thereby improving the comprehensiveness of features and improving the prediction accuracy of user attributes. Structured data includes names, simple interpretable values, etc., such as application ID, user ID, sleep time, misoperation time, etc. These structured data may be relatively directly used for attribute prediction. For example, the high frequency and long-term use of shopping guide applications in application use data, installation and periodic use of women's health applications and other similar user behaviors may be clearly and directly used for predicting gender and age attributes. Since the work and rest of primary and middle school students are more regular, while the work and rest of college students are more free, and there are also characteristics to follow between the elderly and office workers, the sleep habits and other data in health data may be directly used for predicting age attributes.

Unstructured data may include, for example, but not limited to, search record data. As illustrated in FIG. 7, in order to draw a portrait of the user's age and gender, data with relatively important information such as “wife, electric shaver” and the like are extracted from the user's search record data, and it is judged that the user is a male around 30 years old.

In the example embodiments of the disclosure, for example, a method based on hierarchical attention may be used to extract behavior features representing user attributes in unstructured data (corresponding to search feature vectors in the figure). The unstructured data behavior features and multiple ordinary features are combined to improve the accuracy of predicting user attributes (corresponding to merge into user behavior features). For different kinds of data in FIG. 7, firstly, the embedding of unstructured data is obtained by filtering the noise, reducing the dimension and reducing the degree of sparsity through the existing embedding learning network. Then, the embedding of unstructured data extracts the corresponding hierarchical feature vector through two levels of attention network.

A word level encoder (also called as a word level encoder) uses convolutional neural networks (CNN) and a word level attention mechanism to extract important elements in unstructured data, such as “wife, shaver” with a large amount of information. For each line of search content in FIG. 7, word level features in unstructured data may be learned through convolutional neural networks and the word level encoder (may be called a word level attention) to obtain the important degree of the word level.

The query level encoder extracts the importance of respective query texts. The user's continuous search content or related search content over a certain time span may carry specific information. The query text level feature in the unstructured data may be learned through a sequence prediction method (for example, Transformer network) and a query level encoder (may be called a query level attention) to obtain the importance of different query texts.

The word level features and query text level features are extracted through the above two levels of encoders (the word level encoder and the query level encoder), important information of the unstructured data are extracted through the word level features and the query text level features and spliced into the features obtained by learning from other user behaviors (such as the features extracted from the structured data) as feature vectors. For example, the user behavior features extracted from the unstructured data and the ordinary features (application installation condition, application use time and duration, sleep time and duration, etc.) extracted from the structured data are spliced (fused), and then the user behavior feature (UBF) are obtained, so that behavior data sources with more amount of high information may be used and the accuracy of the prediction model is improved by user behaviors on different sides.

At S603, information is predicted using the obtained prediction model.

In the example embodiments of the disclosure, when the user device predicts information using the obtained prediction mode, it may first perform information prediction using the prediction models corresponding to the selected group, respectively, then weighted average output results of the prediction models corresponding to the selected group and determine the weighted average result as the predicted information.

In the example embodiments of the disclosure, the predicted information may include user attribute information.

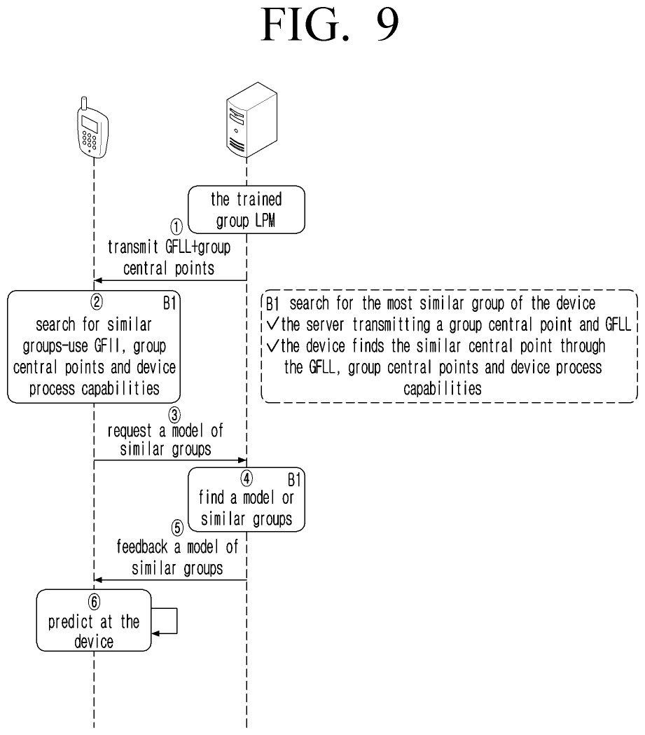

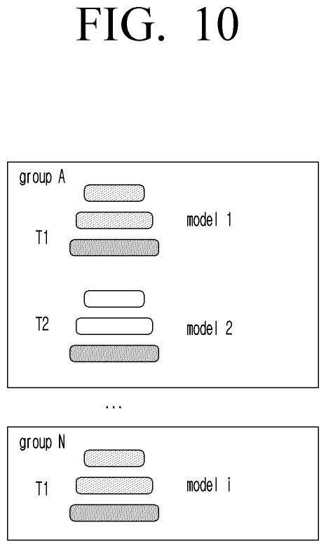

FIG. 9 illustrates a prediction process of a user attribute prediction system in accordance with example embodiments of the disclosure. FIG. 10 illustrates an example of device grouping in accordance with example embodiments of the disclosure.

As illustrated in FIG. 9, the user attribute prediction system includes a server and a device. At operation \textcircled{1}, the server transmits the global feature learning layers (GFLL) in the trained LPM model and the central points of the groups to the device for prediction.

At operation \textcircled{2}, the device extracts user behavior features through the GFLL from local data and calculates the closest group central point according to the user behavior features.

At operation \textcircled{3}, the device transmits the similar model information to the server and requests the similar group mode.

In the example embodiments of the disclosure, two different devices may be distinguished, that is, ordinary user devices and new user devices.

As illustrated in FIG. 10, devices are divided into first layers group A, first layers group B, and first layers group N through the similarity of user behavior features. The devices in first layers group A are divided into high-performance type T1, low-performance type T2, etc., according to the processing performance of the user devices. In the device of T2, a simplified model may be deployed for performance constraints.

Certain historical usage behavior data has been recorded in ordinary user device x. Ordinary user device x needs to find the most similar group and use the model Mi to perform prediction.

For example, when ordinary user device x is a high-performance device, the similarity (sxA=0.75) between ordinary user device x and group A is the highest and more than a threshold thr (such as 0.5), and the similarity with group N (sxN=0.15). In order to predict the attribute of x, x downloads Model 1 of the group of high-performance T1 and uses Model 1 for prediction. For example, the predicted attribute is attributex, attributex=M1(x).

In new user device y, there are not enough historical usage behavior data, and it is necessary to perform prediction (cold start prediction) based on blank or a small amount of historical data. In order to predict such new users, multiple group models most similar to new user device y may be integrated for prediction.

For example, new user device y finds the most similar group, but there is no group having the similarity more than the threshold thr. The example embodiments of the disclosure use the prediction results of the closest group model found to make a weighted average value to predict the attribute of y, for example, attribute_{y}=m₁M₁(y)+m₂M₂. For example, K closest models are selected, and the similarity threshold between new users and groups is thf (such as 0.07), according to the above process, models 1, 2 and i may be selected to predict the attributes of y.

Here, Mj is the output of the model, and a size of a standardized weight Mj is proportional to the similarity. For example, mⱼ=S_{yj}/(Σₖ₌₁^{K}S_{yk}). Syk is the similarity between y and group k in the used K models.

At operation \textcircled{4}, the server searches for the corresponding model according to the request information of the device.

At operation \textcircled{5}, the server feedbacks the model requested by the device.

At operation \textcircled{6}, the device uses the received model (GFLL+ICPL) to perform attribute prediction.

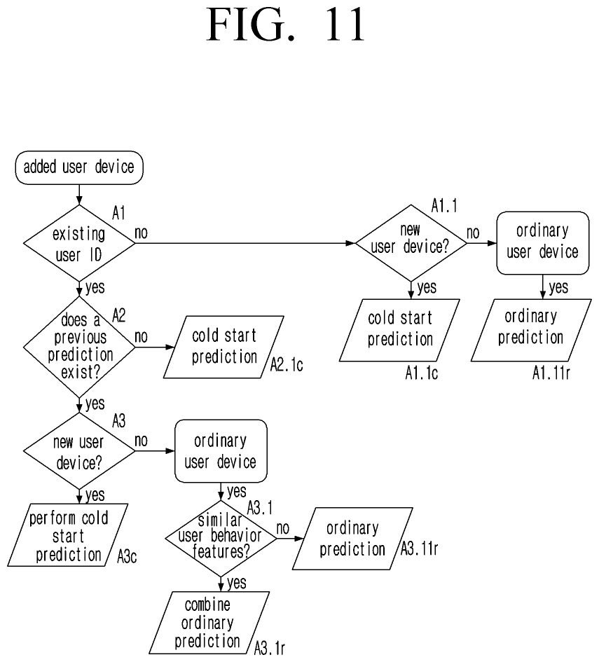

FIG. 11 illustrates a flow diagram of a method for performing user attribute prediction by distinguishing types of devices in accordance with example embodiments of the disclosure.

When performing user attribute prediction, actual users, user IDs and device IDs are distinguished.

The same device ID may be used by different actual users (such as different family members) in reality, and these different actual users may have different user behavior features, different attribute tags and interest preferences. Such actual users need to be treated independently and may be distinguished by using user IDs and device IDs at the same time. The same one actual user may also use multiple devices at the same time. In this case, integrating the user behavior features of multiple devices may better predict attributes and provide personalized services.

As illustrated in FIG. 11, at operation A1, whether the user ID (UID) of the user device has already existed is determined.

If the user ID (UID) does not exist (No), at operation A1.1, whether the user device is a new user device is determined (if there is no or little user behavior data, it may be considered to be a new user device).

If the user device is a new user device (Yes), at operation A.1.1c, a cold start prediction for a new user device or a new user is performed to predict the user attributes of the new user device. If the user device is an ordinary user device, at operation A1.11r, an ordinary prediction for the ordinary user device is performed to predict the user attributes of the ordinary user device.

If the user ID (UID) exists, at operation A2, whether the user ID has an existing prediction is determined. If the existing prediction does not exist, at operation A2.1c, a cold start prediction for a new user device or a new user is performed to predict the user attributes of the user.

If the existing prediction exists, at operation A3, whether the user device is a new user device is determined (if there is no or little user behavior data, it may be considered to be a new user device).

If the user device is a new user device, at operation A3c, a cold start prediction for a new user device or a new user is performed to predict the user attributes of the new user device.

If the user device is not a new user device, at operation A3.1, whether the user behavior features are close to or consistent with the previous record.

If the user behavior features are not close to or inconsistent with the previous records, at operation A3.11r, the cold start prediction for the new user device is performed to predict the user attributes of the user.

If the user behavior features are close to or consistent with the previous records, at operation A3.1r, the previous records are combined to perform ordinary prediction for the ordinary user device to predict the user attributes of the ordinary user device.

In addition, according to the example embodiments of the disclosure, a computer readable storage medium is further provided, on which a computer program is stored, and when the computer program is executed by a processor, the prediction model training method and the information prediction method according to the example embodiments of the disclosure is implemented.

In the example embodiments of the disclosure, the computer readable storage medium may carry one or more programs, and when the computer program is executed, the following may be implemented: transmitting a model to be trained to training devices, wherein the model to be trained includes feature extraction layers for extracting user features and prediction layers for performing information prediction; classifying the respective training devices into at least one group based on the user features extracted by the respective training devices; receiving model parameters obtained by the respective training devices training the model to be trained, wherein the model parameters include first parameters corresponding to the feature extraction layers and second parameters corresponding to the prediction layers; performing global federated aggregation based on the first parameters of the respective training devices to obtain a global federated aggregation result, and performing intra-group federated aggregation on the second parameters of the respective training devices in the group in each of the at least one group to obtain an intra-group federated aggregation result; and transmitting the global federated aggregation result and the corresponding intra-group federated aggregation result to the respective training devices so that the training devices update the parameters of the feature extraction layers based on the global federated aggregation result and update the parameters of the prediction layers based on the intra-group federated aggregation result.

In the example embodiments of the disclosure, the computer readable storage medium may carry one or more programs, and when the computer program is executed, the following may be implemented: transmitting a model to be trained to training devices, wherein the model to be trained includes feature extraction layers for extracting user features and prediction layers for performing information prediction; classifying the respective training devices into at least one group based on the user features extracted by the respective training devices and transmitting a grouping result to the respective training devices; receiving model parameters obtained by the respective training devices training the model to be trained, wherein the model parameters include first parameters corresponding to the feature extraction layers; performing global federated aggregation on the first parameters of the respective training devices to obtain a global federated aggregation result; transmitting the global federated aggregation result to the respective training devices so that the training devices update the feature extraction layers based on the global federated aggregation result.

In the example embodiments of the disclosure, the computer readable storage medium may carry one or more programs, and when the computer program is executed, the following may be implemented: receiving model parameters obtained by training devices in the corresponding group training the model to be trained, wherein the model to be trained includes feature extraction layers for extracting user features and prediction layers for performing information prediction, and the model parameters include second parameters corresponding to the prediction layers; performing intra-group federated aggregation on the second parameters of the respective training devices in the corresponding group to obtain an intra-group federated aggregation result; and transmitting the intra-group federated aggregation result to the respective training devices in the corresponding group so that the training devices update the prediction layers based on the intra-group federated aggregation result.

In the example embodiments of the disclosure, the computer readable storage medium may carry one or more programs, and when the computer program is executed, the following may be implemented: receiving a model to be trained from a server, wherein the model to be trained includes feature extraction layers for extracting user features and prediction layers for performing information prediction; extracting a user feature using the feature extraction layers in the model to be trained, and transmitting the extracted user feature to the server so that the server classifies the respective training devices into at least one group based on the user features extracted by the respective training devices; training the model to be trained, and transmitting model parameters obtained by training to the server, wherein the model parameters include first parameters corresponding to the feature extraction layers and second parameters corresponding to the prediction layers; receiving a global federated aggregation result and an intra-group federated aggregation result from the server, wherein the global federated aggregation result is obtained by the server performing global federated aggregation on the first parameters of the respective training devices, and the intra-group federated aggregation result is obtained by the server performing intra-group federated aggregation on the second parameters of the respective training devices in the corresponding group; and updating the feature extraction layers based on the global federated aggregation result, and updating the prediction layers based on the intra-group federated aggregation result.

In the example embodiments of the disclosure, the computer readable storage medium may carry one or more programs, and when the computer program is executed, the following may be implemented: receiving parameters of feature extraction layers of a prediction model and respective central point information of each group in a predetermined at least one group, wherein the feature extraction layers is used for extracting user features, and the central point information represents an average user feature of the respective user devices within the group; obtaining a prediction model corresponding to the user device based on the feature extraction layers, the respective central point information of each group in the predetermined at least one group and user data of the user device; and predicting information using the obtained prediction model.

The computer readable storage medium may be, for example, but is not limited to, an electrical, magnetic, optical, electromagnetic, infrared, or semiconductor system, device or component, or any combination of the above. More specific examples of a computer readable storage medium may include, but are not limited to, electrical connections with one or more conducting wires, portable computer disks, hard disks, random access memory (RAM), read only memory (ROM), erasable programmable read only memory (EPROM or flash memory), optical fibers, portable compact disk read only memory (CD-ROM), optical storage components, magnetic storage components or any suitable combination of the above. In the example embodiments of the disclosure, the computer-readable storage medium may be any tangible medium containing or storing a computer program, which may be used by or in combination with an instruction execution system, device or component. The computer program included on the computer readable storage medium may be transmitted with any suitable medium, including but not limited to: wire, optical cable, RF (radio frequency), etc., or any suitable combination of the above. A computer readable storage medium may be included in any device; and may also be present separately without being assembled into the device.

In addition, according to the example embodiments of the disclosure, a computer program product is further provided, and the instructions in the computer program product may be executed by a processor of a computer apparatus to accomplish the prediction model training method and the information prediction method according to the example embodiments of the disclosure.

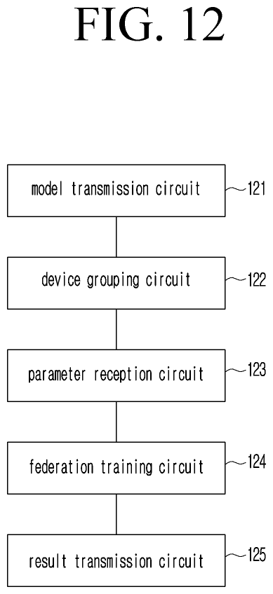

A prediction model training method and an information prediction method according to the example embodiments of the disclosure have been described above in combination with FIGS. 1 to 11. Hereinafter, a prediction model training device and components thereof, an information prediction device and components thereof according to the example embodiments of the disclosure will be described with reference to FIGS. 12 to 16.

According to example embodiments described herein, the prediction model training device and components thereof, and the information prediction device and components thereof may be illustrated in terms of blocks which carry out a described function or functions. These blocks, which may be referred to herein as transmitters, receivers, obtainers, groupers, trainers, predictors, units, modules, or the like, may be hardware components that are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure. According to some example embodiments, these blocks may be implemented by a combination of hardware components, such as a processor, and software components stored in a memory.

According to an example embodiment, the memory stores instructions to be executed by the processor. The memory may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In some examples, the memory can be configured to store larger amounts of information than its storage space. In certain examples, a non-transitory storage medium may store data that can, over time, change (e.g., in Random Access Memory (RAM) or cache). The memory can be an internal storage unit(or circuit) or it can be an external storage unit(or circuit) of the electronic device, a cloud storage, or any other type of external storage.

The processor is configured to execute instructions stored in the memory. The processor may be a general-purpose processor, such as a Central Processing Unit (CPU), an Application Processor (AP), or the like, a graphics-only processing unit(or circuit) such as a Graphics Processing Unit (GPU), a Visual Processing Unit (VPU) and the like. The processor may include multiple cores to execute the instructions.

FIG. 12 illustrates a block diagram of a prediction model training device in accordance with an example embodiment of the disclosure.

Referring to FIG. 12, the prediction model training device includes a model transmission circuit 121, a device grouping circuit 122, a parameter reception circuit 123, a federated training circuit 124 and a result transmission circuit 125.

The model transmission circuit 121 is configured to transmit a model to be trained to training devices, wherein the model to be trained includes feature extraction layers for extracting user features and prediction layers for performing information prediction;

In the example embodiments of the disclosure, the prediction model training device may further include a training device selector(or training deice selecting circuit) configured to acquire user device information transmitted by user devices; and select the training devices from the user devices based on the user device information.

In the example embodiments of the disclosure, the grouping result may include at least one of user behavior data amount, device power consumption, network link status, data rate, whether being connected to a charger.

In the example embodiments of the disclosure, the model transmission circuit 121 may include an extraction layer transmission circuit configured to transmit parameters of the feature extraction layers for extracting user features to the training devices, a group determiner(or group determining circuit) configured to determine pre-trained groups corresponding to the respective training devices, respectively, based on a pre-trained grouping result, and a parameter transmission circuit 153 configured to transmit parameters of the prediction layers corresponding to the pre-trained groups corresponding to the respective training devices to the respective training devices, respectively. The group determiner(or group determining circuit) may be configured to calculate a first similarity between user features of the respective training devices and central points of the respective pre-trained groups, respectively, and determine a pre-trained group having the maximum second similarity in the respective pre-trained groups as a pre-trained group corresponding to the respective training devices, respectively. Or the group determiner(or group determining circuit) may be configured to calculate a second similarity between user features of the respective training devices and central points of the respective pre-trained groups, respectively, and determine a pre-trained group having the maximum second similarity in the respective pre-trained groups as a pre-trained group corresponding to the respective training devices, respectively.

The device grouping circuit 122 is configured to classify the respective training devices into at least one group based on the user features extracted by the respective training devices.

In the example embodiments of the disclosure, the device grouping circuit 122 may be configured to acquire process capabilities of the respective training devices, and classify the respective training devices into at least one group based on the user features and process capabilities of the respective training devices.

In the example embodiments of the disclosure, the device grouping circuit 122 may be configured to cluster the respective training devices based on the user features of the respective training devices to obtain at least one first level groups, and classify, for each of the first level group, the respective training devices based on the process capabilities of the respective training devices within the first level group to obtain at least one second level group, the obtained respective second levels of groups serving as a grouping result.

A parameter reception circuit 123 is configured to receive model parameters obtained by the respective training devices training the model to be trained, wherein the model parameters include first parameters corresponding to the feature extraction layers and second parameters corresponding to the prediction layers.

A federated training circuit 124 is configured to perform global federated aggregation based on the first parameters of the respective training devices to obtain a global federated aggregation result, and performing intra-group federated aggregation on the second parameters of the respective training devices in the group in each of the at least one group to obtain an intra-group federated aggregation result.

In the example embodiments of the disclosure, the federated training circuit 124 may be configured to weighted average the first parameters of the respective training devices to obtain the global federated aggregation result.

In the example embodiments of the disclosure, the federated training circuit 124 may be configured to weighted average the second parameters of the respective training devices in the group in each of the at least one group to obtain the intra-group federated aggregation result.

The result transmission circuit 125 is configured to transmit the global federated aggregation result and the corresponding intra-group federated aggregation result to the respective training devices so that the training devices update the parameters of the feature extraction layers based on the global federated aggregation result and update the parameters of the prediction layers based on the intra-group federated aggregation result.

In the example embodiments of the disclosure, the prediction model training device may further include a grouping result updating circuit configured to update the grouping result.

In the example embodiments of the disclosure, the grouping result updating circuit may include a similarity calculator configured to calculate a similarity between each training device and each of the at least one group, respectively, and an updating circuit configured to update the grouping result based on the similarity. The updating circuit may be configured to, select a group having the maximum similarity with the one training device from the remaining groups in the at least one group, when a similarity between one training device and a group to which the one training device belongs is less than a similarity between the one training device and at least one remaining group in the at least one group; and to update the selected group to be the group of the one training device.

In the example embodiments of the disclosure, the prediction module may be used for predicting user attribute information.

In the example embodiments of the disclosure, the prediction model training device may further include an iterative training circuit configured to repeatedly perform the receiving the model parameter, the global federated aggregation and the intra-group federated aggregation, and the transmitting the global federated aggregation result and the intra-group federated aggregation result until the training ends.

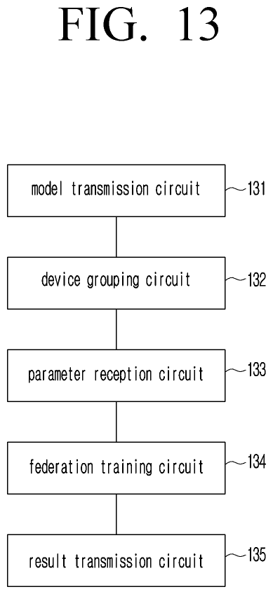

FIG. 13 illustrates a block diagram of a prediction model training device in accordance with another example embodiment of the disclosure.

Referring to FIG. 13, the prediction model training device includes a model transmission circuit 131, a device grouping circuit 132, a parameter reception circuit 133, a federated training circuit 134 and a result transmission circuit 135.

The model transmission circuit 131 is configured to transmit a model to be trained to training devices, wherein the model to be trained includes feature extraction layers for extracting user features and prediction layers for performing information prediction.

A device grouping circuit 132 is configured to classify the respective training devices into at least one group based on the user features extracted by the respective training devices and transmitting a grouping result to the respective training devices.

A parameter reception circuit 133 is configured to receive model parameters obtained by the respective training devices training the model to be trained, wherein the model parameters include first parameters corresponding to the feature extraction layers.

In the example embodiments of the disclosure, the model parameters may include second parameters corresponding to the prediction layers. The grouping result may include at least one of a group to which the training devices belong, central point information of the group to which the training devices belong and server information of the group to which the training devices belong, wherein the central point information represents an average user feature of the respective training devices within the group and a server of the group to which the training devices belong is used for performing intra-group federated aggregation on the second parameters transmitted by the respective training devices within the group.

A federated training circuit 134 is configured to perform global federated aggregation on the first parameters of the respective training devices to obtain a global federated aggregation result.

A result transmission circuit 135 is configured to transmit the global federated aggregation result to the respective training devices so that the training devices update the feature extraction layers based on the global federated aggregation result.

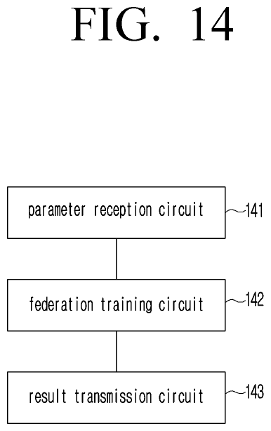

FIG. 14 illustrates a block diagram of a prediction model training device in accordance with another example embodiment of the disclosure.

Referring to FIG. 14, the prediction model training device includes a parameter reception circuit 141, a federated training circuit 142 and a result transmission circuit 143.

The parameter reception circuit 141 is configured to receive model parameters obtained by training devices in the corresponding group training the model to be trained, wherein the model to be trained includes feature extraction layers for extracting user features and prediction layers for performing information prediction, and the model parameters include second parameters corresponding to the prediction layers;

The federated training circuit 142 is configured to perform intra-group federated aggregation on the second parameters of the respective training devices in the corresponding group to obtain an intra-group federated aggregation result.

The result transmission circuit 143 is configured to transmit the intra-group federated aggregation result to the respective training devices in the corresponding group so that the training devices update the prediction layers based on the intra-group federated aggregation result.

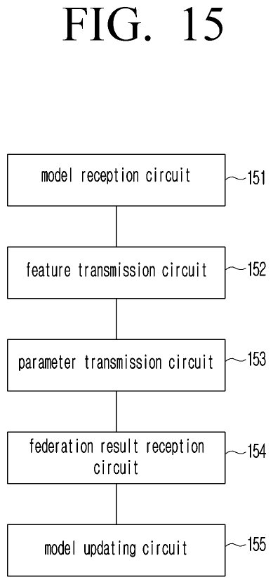

FIG. 15 illustrates a block diagram of a prediction model training device in accordance with another example embodiment of the disclosure.

Referring to FIG. 15, the prediction model training device includes a model reception circuit 151, a feature transmission circuit 152, a parameter transmission circuit 153, a federated result reception circuit 154 and a model updating circuit 155.

The model reception circuit 151 is configured to receive a model to be trained from the server, wherein the model to be trained includes feature extraction layers for extracting user features and prediction layers for performing information prediction.

In the example embodiments of the disclosure, the model reception circuit 151 may be configured to receive parameters of the feature extraction layers for extracting user features from the server, and receive prediction layers parameters corresponding to the group to which the training device belongs from the server, wherein the prediction layers parameters corresponding to the group to which the training device belongs is determined by the server from parameters of the respective prediction layers obtained by pre-training based on the grouping result.

The feature transmission circuit 152 is configured to extract a user feature using the feature extraction layers in the model to be trained, and transmitting the extracted user feature to the server so that the server classifies the respective training devices into at least one group based on the user features extracted by the respective training devices.

The parameter transmission circuit 153 is configured to train the model to be trained, and transmit model parameters obtained by training to the server, wherein the model parameters include first parameters corresponding to the feature extraction layers and second parameters corresponding to the prediction layers;

In the example embodiments of the disclosure, the parameter transmission circuit 153 may be configured to receive the grouping result transmitted from a first server, and transmitting the first parameters in the model parameters to the first server, and determine second server information of the group to which the training device belongs based on the grouping result, and transmit the second parameters in the model parameters to a second server. The federated result reception circuit 154 may be configured to receive the global federated aggregation result from the first server, and receive the intra-group federated aggregation result from the second server.

In the example embodiments of the disclosure, the grouping result may include at least one of a group to which the training devices belong, central point information of the group to which the training devices belong and server information of the group to which the training devices belong, wherein the central point information represents an average user feature of the respective training devices within the group.

The federated result reception circuit 154 is configured to receive a global federated aggregation result and an intra-group federated aggregation result from the server, wherein the global federated aggregation result is obtained by the server performing global federated aggregation on the first parameters of the respective training devices, and the intra-group federated aggregation result is obtained by the server performing intra-group federated aggregation on the second parameters of the respective training devices in the corresponding group.

The model updating circuit 155 is configured to update the feature extraction layers based on the global federated aggregation result, and update the prediction layers based on the intra-group federated aggregation result.

In the example embodiments of the disclosure, the prediction module may be used for predicting user attribute information.

In the example embodiments of the disclosure, the prediction model training device may further include an iterative training circuit configured to repeatedly perform the training on the model to be trained, the transmitting model parameters to the server, the receiving a global federated aggregation result and an intra-group federated aggregation result from the server and the updating the feature extraction layers and the prediction layers, until the training ends.

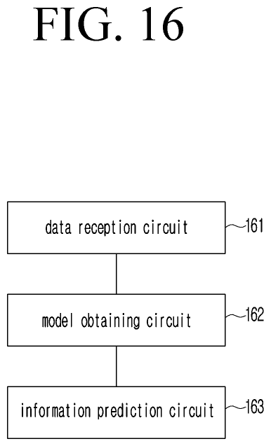

FIG. 16 illustrates a block diagram of an information prediction device in accordance with example embodiments of the disclosure.

Referring to FIG. 16, the information prediction device includes a data reception circuit 161, a model obtaining circuit 162 and an information predicting circuit 163.

A data reception circuit 161 is configured to receive parameters of feature extraction layers of a prediction model and respective central point information of each group in a predetermined at least one group, wherein the feature extraction layers is used for extracting user features, and the central point information represents an average user feature of the respective user devices within the group.

The model obtaining circuit 162 is configured to obtain a prediction model corresponding to the user device based on the feature extraction layers, the respective central point information of each group in the predetermined at least one group and user data of the user device.

In the example embodiments of the disclosure, the model obtaining circuit 162 may include a feature extractor configured to extract a user feature from the user data of the user device using the feature extraction layers, and a model determining circuit configured to determine a prediction model corresponding to the user device based on the user feature and the respective central point information of each group in the predetermined at least one group.

In the example embodiments of the disclosure, the model determining circuit may be configured to select a group from the predetermined at least one group based on the user feature and the respective central point information of each group in the predetermined at least one group, and receive a prediction model corresponding to the selected group in the predetermined at least one group as a determined prediction model corresponding to the user device.

In the example embodiments of the disclosure, the model determining circuit may be configured to calculate a similarity between the user feature and the respective central point information of each group in the predetermined at least one group, select a group with the maximum similarity from the predetermined at least one group as a first level group, acquire process capability of the user device, and select a second level group from the first level group based on the process capability and use the selected second level group as the selected group.

In the example embodiments of the disclosure, the model determining circuit may be configured to calculate a similarity between the user feature and the respective central point information of each group in the predetermined at least one group, select groups with the maximum similarity and less than or equal to the preset number from the predetermined at least one group when all the calculated similarities are less than a threshold, and determine the prediction models corresponding to the selected groups as prediction models corresponding to the user device. The information predicting circuit may be configured to perform information prediction using the prediction models corresponding to the selected group, respectively, and weighted average output results of the prediction models corresponding to the selected group and determining the weighted average result as the predicted information.

In the example embodiments of the disclosure, the feature extracting circuit may be configured to extract a first user feature from unstructured data in the user data and extracting a second user feature from structured data in the user data, and fuse the first user feature and the second user feature to obtain the user feature.

In the example embodiments of the disclosure, the feature extractor may be configured to extract, for at least one unstructured data, a word level feature through a word level encoder and extract a query text level feature through a query layer level encoder, and obtain a first user feature corresponding to the unstructured data based on the word level feature and the query text level feature.

The information predicting circuit 163 is configured to predict information using the obtained prediction model.

In the example embodiments of the disclosure, the predicted information may include user attribute information.

For the device in the above embodiments, the specific manners in which respective blocks or units or circuits perform operations have been described in detail in the example embodiments of the method, which will not be explained in detail here.

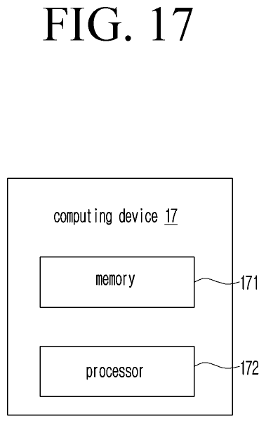

A prediction model training device and an information prediction device according to the example embodiments of the disclosure have been described above in combination with FIGS. 12 to 16. Next, the computing device in accordance with example embodiments of the disclosure is described in combination with FIG. 17.

FIG. 17 illustrates a diagram of a computing device in accordance with example embodiments of the disclosure.

Referring to FIG. 17, the computing device 17 according to the example embodiments of the disclosure includes a memory 171 and a processor 172, wherein a computer program is stored on the memory 171, and the processor 172 implements the prediction model training method and the information prediction method according to the example embodiments of the disclosure when the computer program is executed by the processor 172.

In the example embodiments of the disclosure, when the computer program is performed by the processor 172, the following operations may be implemented: transmitting a model to be trained to training devices, wherein the model to be trained includes feature extraction layers for extracting user features and prediction layers for performing information prediction; classifying the respective training devices into at least one group based on the user features extracted by the respective training devices; receiving model parameters obtained by the respective training devices training the model to be trained, wherein the model parameters include first parameters corresponding to the feature extraction layers and second parameters corresponding to the prediction layers; performing global federated aggregation based on the first parameters of the respective training devices to obtain a global federated aggregation result, and performing intra-group federated aggregation on the second parameters of the respective training devices in the group in each of the at least one group to obtain an intra-group federated aggregation result; and transmitting the global federated aggregation result and the corresponding intra-group federated aggregation result to the respective training devices so that the training devices update the parameters of the feature extraction layers based on the global federated aggregation result and update the parameters of the prediction layers based on the intra-group federated aggregation result.

In the example embodiments of the disclosure, when the computer program is performed by the processor 172, the following operations may be implemented: transmitting a model to be trained to training devices, wherein the model to be trained includes feature extraction layers for extracting user features and prediction layers for performing information prediction; classifying the respective training devices into at least one group based on the user features extracted by the respective training devices and transmitting a grouping result to the respective training devices; receiving model parameters obtained by the respective training devices training the model to be trained, wherein the model parameters include first parameters corresponding to the feature extraction layers; performing global federated aggregation on the first parameters of the respective training devices to obtain a global federated aggregation result; transmitting the global federated aggregation result to the respective training devices so that the training devices update the feature extraction layers based on the global federated aggregation result.

In the example embodiments of the disclosure, when the computer program is performed by the processor 172, the following operations may be implemented: receiving model parameters obtained by training devices in the corresponding group training the model to be trained, wherein the model to be trained includes feature extraction layers for extracting user features and prediction layers for performing information prediction, and the model parameters include second parameters corresponding to the prediction layers; performing intra-group federated aggregation on the second parameters of the respective training devices in the corresponding group to obtain an intra-group federated aggregation result; and transmitting the intra-group federated aggregation result to the respective training devices in the corresponding group so that the training devices update the prediction layers based on the intra-group federated aggregation result.

In the example embodiments of the disclosure, when the computer program is performed by the processor 172, the following operations may be implemented: receiving a model to be trained from a server, wherein the model to be trained includes feature extraction layers for extracting user features and prediction layers for performing information prediction; extracting a user feature using the feature extraction layers in the model to be trained, and transmitting the extracted user feature to the server so that the server classifies the respective training devices into at least one group based on the user features extracted by the respective training devices; training the model to be trained, and transmitting model parameters obtained by training to the server, wherein the model parameters include first parameters corresponding to the feature extraction layers and second parameters corresponding to the prediction layers; receiving a global federated aggregation result and an intra-group federated aggregation result from the server, wherein the global federated aggregation result is obtained by the server performing global federated aggregation on the first parameters of the respective training devices, and the intra-group federated aggregation result is obtained by the server performing intra-group federated aggregation on the second parameters of the respective training devices in the corresponding group; and updating the feature extraction layers based on the global federated aggregation result, and updating the prediction layers based on the intra-group federated aggregation result.

In the example embodiments of the disclosure, when the computer program is performed by the processor 172, the following operations may be implemented: receiving parameters of feature extraction layers of a prediction model and respective central point information of each group in a predetermined at least one group, wherein the feature extraction layers is used for extracting user features, and the central point information represents an average user feature of the respective user devices within the group; obtaining a prediction model corresponding to the user device based on the feature extraction layers, the respective central point information of each group in the predetermined at least one group and user data of the user device; and predicting information using the obtained prediction model.

The computing device in the example embodiments of the disclosure may include, but is not limited to, devices such as a mobile phone, a notebook computer, a PDA (personal digital assistant), a pad (tablet computer), a desktop computer, etc. The computing device shown in FIG. 17 is only an example and should not impose any restrictions on the function and scope of use of the example embodiments of the disclosure.

The prediction model training method and device, and an information prediction method and device according to the example embodiments of the disclosure have been described above with reference to FIGS. 1 to 17. However, it should be understood that: the prediction model training apparatus and the units(or the circuits) thereof, the information prediction device and the units(or the circuits) thereof shown in FIGS. 12 to 16 may be configured as software, hardware, firmware or any combination of the above items to perform specific functions, respectively. The computing device shown in FIG. 17 is not limited to comprising the components as shown above, but may add or delete some components as needed, and the above components may also be combined.

The prediction model training method and device according to the example embodiments of the application reduce the accuracy loss in the federated learning training process through the federated learning based on clustering and hierarchical aggregation, under the common situation of diversified and relevant distribution of user behavior data, thereby improving the prediction accuracy of the user attribute prediction model.

In addition, the prediction model training method and device according to the example embodiments of the disclosure enhance the accuracy of federated learning training of the user attribute prediction model and availability by extracting and adding features of unstructured data, thereby improving the prediction accuracy of the user attribute prediction model.

Even if the disclosure has been particularly shown and described with reference to example embodiments thereof, it shall be understood by those skilled in the art that various changes in form and details may be made therein without departing from the spirit and scope of the disclosure as defined by the claims.

What is claimed is:

1. A prediction model training method, which is performed by a server, comprising:
transmitting, to a plurality of training devices, a model to be trained by the plurality of training devices, wherein the model to be trained comprises feature extraction layers configured to extract user features and prediction layers configured to perform information prediction;
classifying the plurality of training devices into at least one group based on the user features extracted by the training devices;
receiving, from the plurality of training devices, model parameters obtained by the respective training devices training the model to be trained, wherein the model parameters comprise first parameters corresponding to the feature extraction layers and second parameters corresponding to the prediction layers;
performing global federated aggregation based on the first parameters to obtain a global federated aggregation result;
performing intra-group federated aggregation for each of the at least one group, based on the second parameters of one or more of the plurality of training devices in a respective group, among each of the at least one group, to obtain an intra-group federated aggregation result; and
transmitting, to each of the plurality of training devices, the global federated aggregation result and the intra-group federated aggregation result associated the respective group of the respective training device, so that the plurality of training devices update the first parameters of the feature extraction layers based on the global federated aggregation result and update the second parameters of the prediction layers based on the intra-group federated aggregation result.

2. The prediction model training method of claim 1, further comprises:
acquiring user device information from a plurality of user devices; and
selecting the plurality of training devices from the plurality of user devices based on the user device information.

3. The prediction model training method of claim 1, wherein the transmitting the model to be trained to the training devices comprises:
transmitting first information corresponding to the feature extraction layers for extracting user features to the plurality of training devices;
determining pre-trained groups of the plurality of training devices, respectively, based on a pre-trained grouping result; and
transmitting, to the plurality of training devices, second information corresponding to the prediction layers based on the pre-trained groups.

4. The prediction model training method of claim 1, wherein the classifying the respective training devices into the at least one group comprises:
acquiring process capabilities of each of the plurality of training devices; and
classifying the plurality of training devices into one or more groups among the at least one group based on the user features and the process capabilities of the plurality of straining devices.

5. The prediction model training method of claim 4, wherein the classifying the plurality of training devices into the at least one group further comprises:
clustering the plurality of training devices based on the user features of the respective training devices to obtain at least one first level group; and
classifying, for each of the first level groups, the respective training devices based on the process capabilities of the respective training devices within the first level group to obtain at least one second level group, the obtained respective second levels of groups serving as a grouping result.

6. The prediction model training method of claim 1, wherein the performing global federated aggregation based on the first parameters of the respective training devices comprises:
weighted averaging the first parameters of the respective training devices to obtain the global federated aggregation result.

7. The prediction model training method of claim 1, wherein the performing intra-group federated aggregation on the second parameters of the respective training devices in the group in each of the at least one group comprises:
weighted averaging the second parameters of the respective training devices in the group in each of the at least one group to obtain the intra-group federated aggregation result.

8. The prediction model training method of claim 1, wherein the training method further comprises:
updating the grouping result.

9. The prediction model training method of claim 8, wherein the updating the grouping result comprises:
calculating a similarity between each of the plurality of training devices and each of the at least one group, respectively; and
updating the grouping result based on the similarity.

10. The prediction model training method of claim 1, wherein the prediction model is configured to predict predicting user attribute information.

11. The prediction model training method of claim 1, further comprising:
repeatedly performing the operations of:
receiving the model parameter,
performing the global federated aggregation and the intra-group federated aggregation, and
transmitting the global federated aggregation result and the intra-group federated aggregation result until end of training.

12. A prediction model training method, which is performed by a server, the method comprising:
transmitting a model to be trained to a plurality of training devices, the model to be trained comprising feature extraction layers configured to extract user features and prediction layers configured to perform information prediction;
classifying the plurality of training devices into at least one group based on the user features extracted by the plurality of training devices and transmitting a grouping result to the plurality of training devices;
receiving model parameters obtained by the plurality of training devices training the model to be trained, wherein the model parameters comprise first parameters corresponding to the feature extraction layers;
performing global federated aggregation on the first parameters of the respective training devices to obtain a global federated aggregation result;
transmitting the global federated aggregation result to the plurality of training devices so that the plurality of training devices update the feature extraction layers based on the global federated aggregation result.

13. A prediction model training method, which is performed by a server, comprising:
receiving model parameters obtained by a plurality of training devices in a first group, among at least one group, training the model to be trained, the model to be trained comprising feature extraction layers configured to extract user features and prediction layers configured to perform information prediction, and the model parameters comprise second parameters corresponding to the prediction layers;
performing intra-group federated aggregation on the second parameters of the plurality of training devices in the first group to obtain an intra-group federated aggregation result; and
transmitting the intra-group federated aggregation result to the plurality of training devices in the first group so that the plurality of training devices update the prediction layers based on the intra-group federated aggregation result.

14. A prediction model training method, which is performed by a training device, the method comprising:
receiving a model to be trained from a server, the model to be trained comprising feature extraction layers configured to extract user features and prediction layers configured to information prediction;
extracting a user feature using the feature extraction layers in the model to be trained, and transmitting the extracted user feature to the server to classify the training device into one of at least one group based on the user features;
training the model to be trained, and transmitting model parameters obtained by training to the server, wherein the model parameters comprise first parameters corresponding to the feature extraction layers and second parameters corresponding to the prediction layers;
receiving a global federated aggregation result and an intra-group federated aggregation result from the server, wherein the global federated aggregation result is obtained by the server performing global federated aggregation on the first parameters of the respective training devices, and the intra-group federated aggregation result is obtained by the server performing intra-group federated aggregation on the second parameters of the respective training devices in the corresponding group; and
updating the feature extraction layers based on the global federated aggregation result, and updating the prediction layers based on the intra-group federated aggregation result.

15. An information prediction method, which is executed by a user device, the method comprising:
receiving parameters of feature extraction layers of a prediction model and first central point information corresponding to a first group, among at least one group, the feature extraction layers configured to extract user features, and the first central point information representing an average user feature of user devices within the first group;
obtaining the prediction model corresponding to the user device based on the feature extraction layers, the first central point information and user data of the user device; and
predicting information using the obtained prediction model.
